(19) United States
(12) Patent Application Publication
(10) Pub. No.: US 2008/0173759 A1
(43) Pub. Date: Jul. 24, 2008

(54) APPARATUS WITH AN EXPANDING BAND DRIVE, AND ITS USE IN AIRCRAFT CONSTRUCTION

(75) Inventor: Alexander Eck, Poppenhausen (DE)

Correspondence Address: BACHMAN & LAPOINTE, P.C., 900 CHAPEL STREET, SUITE 1201, NEW HAVEN, CT, 06510, US

(73) Assignee: WITTENSTEIN AG, Igersheim (DE)

(21) Appl. No.: 11/969,242

(22) Filed: Jan. 4, 2008

(30) Foreign Application Priority Data
Jan. 19, 2007 (DE) 10 2007 003 793.9

(51) Int. Cl. B64C 7/00; B65G 15/30

(52) U.S. Cl. 244/129.1; 244/129.3; 193/1

(57) ABSTRACT

In the case of apparatuses which are intended in particular for aircraft construction and have a movement device for objects such as films, cloths, lids or the like, expanding band drives are in each case used for this purpose, whose expanding bands carry out limited linear movements, in which case the apparatuses can be used as waterless toilets, supply containers for hand towels which can be rolled up and/or unrolled, as a sun protection device for aircraft cabin windows, as a conveyor belt for luggage or transport containers with closable lids for on-board luggage.

### BACKGROUND OF THE INVENTION

The invention relates to an apparatus having a movement device for objects such as films, cloths, lids and the like, and to its use in particular in aircraft construction.

Particularly in aircraft construction, conventional technology is increasingly being superseded by novel technologies which are now entering fields, keyword A380 super-jumbo, which already border on the limits of what is possible. Furthermore, an improvement is also possible in design details, such as the equipment of aircraft toilets or aircraft windows.

This is the purpose of the present invention, which is based on the object of providing an apparatus in particular for aircraft construction, by means of which objects which are required in an aircraft such as films, cloths, lids or the like can be moved in their corresponding functions in a space-saving and nevertheless safe manner.

### SUMMARY OF THE INVENTION

According to the invention, this object is achieved by an apparatus having a movement device in the form of an expanding band drive, to be precise whose expanding band can carry out limited linear movements.

In principle, the use of expanding bands is known, for example in transmissions according to DE 38 35 064 C1, which discloses an arrangement for converting a translational movement to a rotary movement, and vice versa. The expanding bands provided here are in each case a so-called cambered metal or plastic band which is closed to form an endless loop and rotates between two rotation axes, which are each bounded on both sides by discs, with an annular gap, whose width is variable and which tapers outwards, being provided between each of the discs thus making it possible to produce different transmission ratios in that the rotating band can be spread out, by varying the axial annular gap distance, at different radial distances between the side walls of the annular gap.

In this case, a cambered band means a band composed of a stiff material such as steel which is cambered transversely with respect to its longitudinal direction, that is to say it is plastically deformed such that it has a curvature, which can be elastically cancelled out, in the transverse direction. A further example of a cambered metal band is a cambered self-rolling-up metal measurement tape.

At the same time, DE 38 35 064 C1 discloses an apparatus in which each of the two ends of a cambered band can be connected to a body which can be moved backwards and forwards in the longitudinal direction of the band.

The major advantage of such cambered bands is, however, that they can be wound up or rolled up flat on a drum with side guide edges. This means that, when a cambered band is deflected around an axis running transversely with respect to its longitudinal extent, it loses its curvature in the transverse cambered direction again, and can thus be wound up flat, saving space. Conversely, when the band is being unwound from a drum such as this, it resumes its transverse curvature, therefore giving it extremely good resistance to pressure in its longitudinal direction again. The latter is necessary in order that the expanding band can absorb tension and compression forces without kinking during linear movement.

According to the present invention, an apparatus can take the form of a waterless aircraft toilet in that this apparatus has an expanding band drive whose expanding band is connected to a dispenser for a film bag or the like, to be precise with the expanding band for this purpose having a gripper at its free end, for driving the film bag or the like.

During use of the waterless aircraft toilet, only its expanding band drive then need be switched on, following which the gripper of the expanding band grips a film bag or the like from the dispenser, with this film bag or the like then being transported by a limited linear movement of the expanding band over the toilet opening. The gripper is then released and the expanding band is moved back to its initial position again, that is to say it is rolled up again. The used film bag is then sucked away by vacuum pressure, in a known manner.

A further application of an expanding band drive according to the invention is for an apparatus as a supply container for hand towels, refuse sacks or the like which can be rolled up and/or unrolled and can advantageously be installed in an aircraft toilet. In this case, the free end of the expanding band of the movement device is connected, in the form of an expanding band drive, to the start of the content of the supply container, with the free end of the expanding band for this purpose having a gripper for driving the hand towels, refuse sacks or the likes which can be rolled up and/or unrolled.

When using an apparatus such as this, for example as a hand towel dispenser, only its expanding band drive then need be switched on, after which the gripper of the expanding band grips a hand towel and then supplies this by means of a limited linear movement to the consumer, with the gripper then being released again, and the expanding band returning to its initial position.

Furthermore, in an apparatus according to the invention, an expanding band drive can advantageously be used as a sun protection device, to be precise by the movement device in the form of the expanding band drive being connected by the free end of its expanding band to a sun protection means which can preferably be moved linearly. This makes it possible in a simple manner, for example for all of the aircraft cabin windows or subareas thereof, to be automatically darkened or, conversely, lightened.

It is also possible to use the expanding band of an expanding band drive as a conveyor belt, to be precise for limited distances, for example in the field of airports.

Finally, according to the invention, an apparatus can be provided as a transport container with closable lids, preferably for aircraft luggage, in which the movement device, which is in the form of an expanding band drive, is connected by its expanding band to the lids of the transport container in order to operate the lids, with the lids then being operated by a limited angular movement. In this case as well, it is possible, for example, for all the transport containers in an aircraft cabin to be equipped with an expanding band drive such as this, so that they can advantageously be closed and opened centrally.

### BRIEF DESCRIPTION OF THE DRAWINGS

Further features and advantages of the present invention will become evident from the following description of a plurality of exemplary embodiments, in conjunction with the drawing, in which:

FIG. 1 shows a schematically illustrated side view of the principle of an expanding band drive for an apparatus as a waterless toilet.

FIG. 2 shows a schematically illustrated side view of the principle of an expanding band drive for an apparatus as a supply container for hand towels which can be unrolled,

FIG. 3 shows a schematically illustrated cross section through an aircraft cabin window and, in this case, the principle of an expanding band drive for an apparatus as a sun protection device,

FIG. 4 shows a schematically illustrated side view of the principle of an expanding band drive for an apparatus as a conveyor belt, and

FIG. 5 shows a schematically illustrated side view of the principle of an expanding band drive for an apparatus as a transport container with a closable lid, preferably for aircraft luggage.

### DETAILED DESCRIPTION

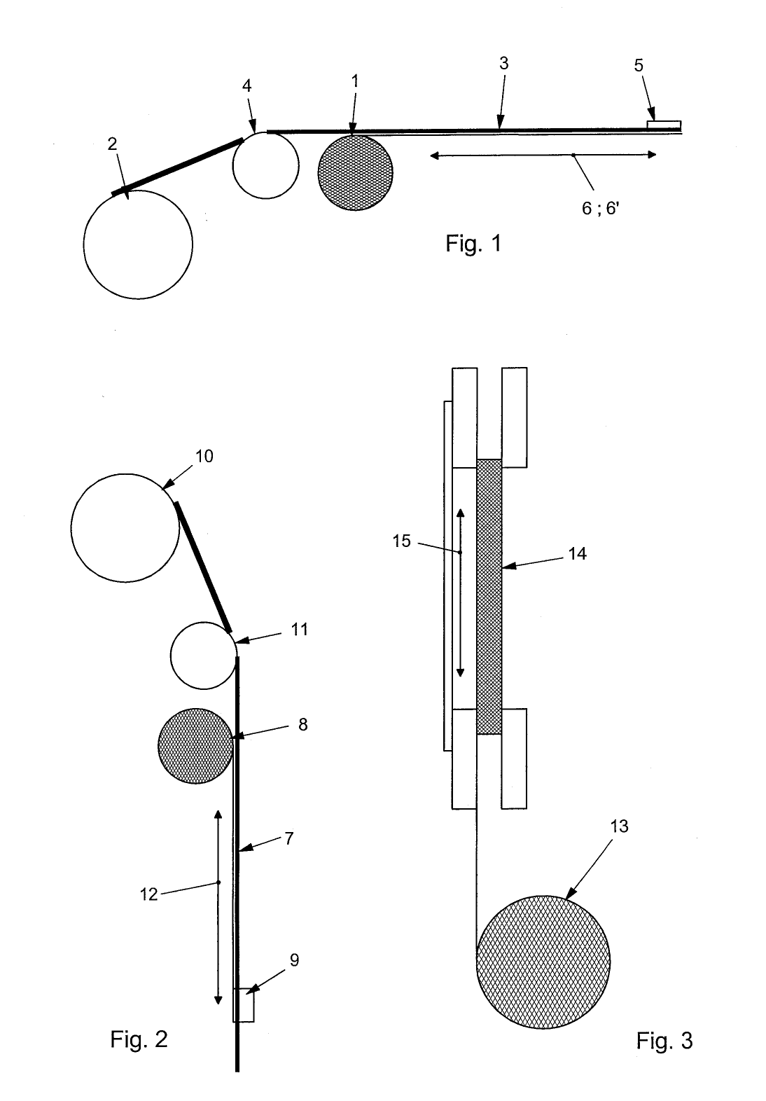

The side view of the principle of an expanding band drive for an apparatus as a waterless toilet in particular for aircraft, as illustrated schematically in FIG. 1, has an expanding band 1, a dispenser 2 for film bags 3, a deflection roller 4 for the film bags 3, and a gripper 5.

In order to operate a waterless aircraft toilet such as this, once the expanding band drive has been switched on, the gripper 5 of the expanding band 1 grips a film bag 3 which has been wound up on the roller of the dispenser 2, and then transports it by means of a limited linear movement 6 of the expanding band 1 over the toilet opening 6′, with the gripper 5 then releasing it again and the expanding band 1 returning to its initial position in order to pick up another film bag for the next operation. The old or full film bag is sucked away by vacuum pressure, in the normal way.

As a further exemplary embodiment, FIG. 2 schematically illustrates an apparatus as a supply container for paper hand towels 7 which can be unrolled and are supplied with the aid of a gripper 9, which is provided at the free end of a motor-driven expanding band 8, over a deflection roller 11, corresponding to the linear movement indicated by the arrow 12, downwards to the consumer, once the supply roller 10 has been switched on, with the gripper 9 then being released again and the expanding band 8 moving back to its initial position for the next user. The used hand towel 7 is then torn off by the user, who throws it in a refuse container.

FIG. 3 shows, as a third exemplary embodiment, a schematically illustrated cross section of an aircraft cabin window, in this case with an apparatus as a sun protection device which has a motor-driven expanding band 13 and a flat sun protection means 14. The sun protection means 14 is attached to the free end of the expanding band 13 so that it can be moved upwards or downwards corresponding to the linear movement indicated by an arrow 15, to be precise between a two-shell aircraft fuselage wall. The cabin windows can thus all be darkened at the same time or in places, or else released again, as required under central control.

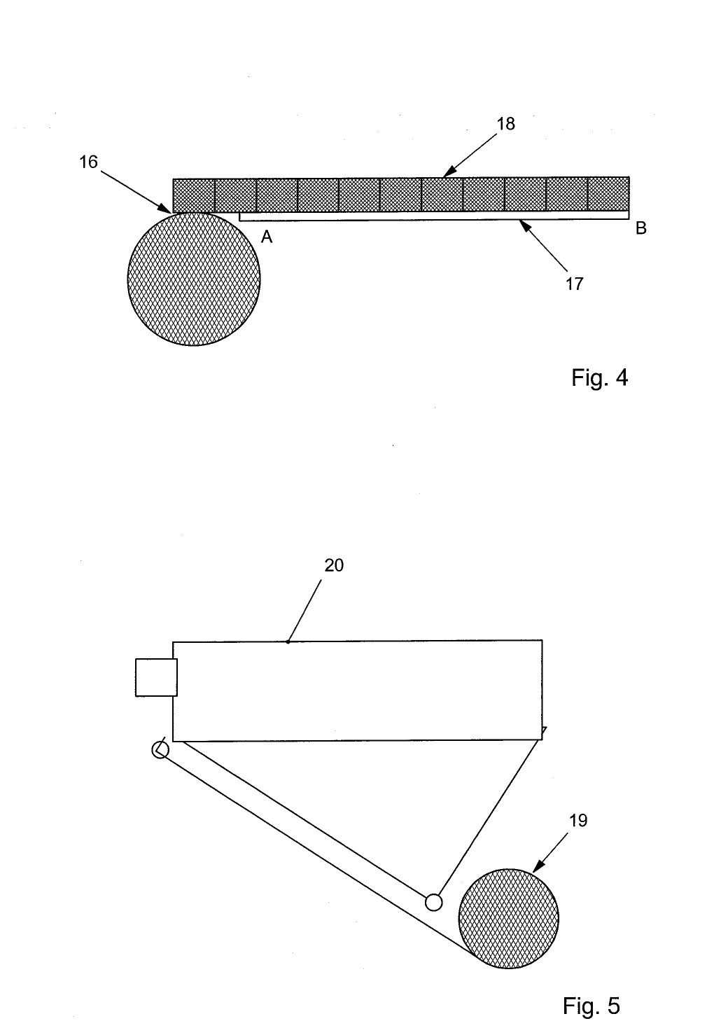

FIG. 4 shows, once again schematically and in the form of a side view, one exemplary embodiment in the form of an apparatus as a conveyor belt, in which a motor-driven expanding band 16 can slide on a base 17 in the form of a limited linear movement and, in the process, can transport an item to be transported 18 from A to B, or vice versa.

Finally, FIG. 5 shows, schematically and in the form of a side view, one exemplary embodiment in the form of an apparatus as a transport container with a closable lid, preferably for aircraft hand luggage. In this case, the movement device is a motor-driven expanding band 19 which is connected to the lid of the luggage repository 20, with the lid being operated by a limited angular movement.

Overall, the present invention specifies an innovative use of the expanding band drive, in particular in aircraft construction, which can be used reliably, in a space-saving manner and above all cost-effectively for widely different objects, for example for supplying film bags, hand towels or refuse sacks and the like.

1. Apparatus having a movement device for objects such as films, cloths, lids or the like, wherein the movement device is in the form of an expanding band drive whose expanding band (1; 8; 13; 16; 19) carries out restrictive linear movements (6; 12; 15; A-B).

2. Apparatus as a waterless toilet according to claim 1, wherein the expanding band (1) of the movement device is connected to a dispenser (2) for film bags (3) or the like.

3. Apparatus according to claim 2, wherein the expanding band (1) of the movement device has a gripper (5) at its free end, in order to drive a film bag (3) or the like.

4. Method for covering a waterless toilet with a film bag having an expanding band drive according to claim 3, wherein, when the expanding band drive is switched on, the gripper (5) of the expanding band (1) grips a film bag (3) or the like in the area of the film bag dispenser (2), and this film bag (3) or the like is then transported by a limited linear movement (6) of the expanding band (1) over the toilet opening (6′), with the gripper (5) then being detached again and the expanding band (1) returning to its original position.

5. A supply container for objects, which can be rolled up and/or unrolled comprises a movement device comprising an expanding band (8) having a free end, the free end of the expanding band (8) of the movement device is connected to the start of the content of the supply container (10).

6. Apparatus according to claim 5, wherein the free end of the expanding band (8) of the movement device has a gripper (9) for driving the object (7) which can be rolled up and/or unrolled.

7. Method for rolling up and/or unrolling objects according to claim 6, wherein, when the expanding band drive is switched on, the gripper (9) of the expanding band (8) grips an object (7), which is supplied by means of a limited linear movement (12) to the consumer, with the gripper (9) then being detached again and the expanding band (8) returning to its initial position.

8. A sun protection device comprises a movement device comprising an expanding band (8) having a free end, the movement device is connected by the free end to a sun protection means (14) which can be moved linearly.

9. A conveyor belt comprises a movement device comprising an expanding band (8) having a free end, wherein a expanding band (16) of the expanding band drive is a conveyor belt.

10. A transport container comprises a movement device comprising an expanding band (8) having a free end, the movement device, which is in the form of an expanding band drive, is connected by its expanding band (19) to lids of the transport container (20) in order to operate the lids.

11. Apparatus according to claim 10, wherein the lids are operated by a limited angular movement.
